(19) United States
(12) Patent Application Publication
(10) Pub. No.: US 2004/0203605 A1
(43) Pub. Date: Oct. 14, 2004

(54) Security arrangement

(76) Inventor: John Aram Safa, Nottingham (GB)

Correspondence Address: SMITH-HILL AND BEDELL, 12670 N W BARNES ROAD, SUITE 104, PORTLAND, OR, 97229

(21) Appl. No.: 10/382,293

(22) Filed: Mar. 4, 2003

(30) Foreign Application Priority Data
Mar. 5, 2002 (GB) 0205046.6

(51) Int. Cl. H04M 1/66

(52) U.S. Cl. 455/411; 455/435.1

(57) ABSTRACT

A mobile communication network 12 provides communication between devices 10 and is controlled at 14. When a user wishes to gain access to the network 12, a device 10 is required to send a request signal to the control 14. This request signal identifies the user device, not the user. The control makes security checks to ensure that the device is authorised, before returning an authorising signal 20. The user device is configured to prevent communication by the user until an authorising signal has been received.

Security is improved by requiring the user device to be identified. Details of devices 10 which have been stolen can be recorded by the control 14 so that those devices will not, in future, be authorised for use of the network 12. The value of a stolen device 10 to a thief is therefore reduced or removed.

The present invention relates to security arrangements and in particular, to arrangements for preventing unauthorised access to commercial communication networks. The invention is particularly, but not exclusively applicable to wireless mobile communication networks.

Commercial communication networks, particularly wireless mobile networks for communication by mobile telephones or other mobile communication devices, provide a communication service for which a user is required to make payment. The user uses a mobile telephone or other user device to gain access to the communications network. The user of the device is identified to the network operator when the user device initiates communication with the network, usually by means of a removable memory device called a SIM card. This is inserted in the user device and contains data which uniquely identifies the user. This allows the network operator to check that the user is authorised to use the network, before allowing communication. For example, a user who has not made a required subscription payment can be barred from use of the network when that user's SIM card is used to seek access to the network.

Mobile communication devices such as mobile telephones are becoming increasingly sophisticated in the functions provided and in consequence, they are becoming increasingly valuable. It is now common for users to carry them at all times. They are becoming more and more compact and lightweight. They are therefore becoming increasingly vulnerable to loss and theft. The value of a lost or stolen device continues to increase. The problem of theft of mobile telephones and other mobile devices is becoming a social problem of increasing concern to the public. A user who has an outdated device containing a legitimate SIM card can readily upgrade the device by obtaining a lost or stolen device of greater value or functionality, and render this fully operable by inserting the user's legitimate SIM card in place of the SIM card which identifies the true owner of the device. The ease with which this is accomplished further increases the value of a high quality device to a thief.

The present invention provides a security arrangement for a communications network of the type which includes a plurality of user devices operable to communicate with each other by means of signals propagated over the network, and network control means operable to authorise user devices, wherein at least one of the devices has device control means operable to send a request message over the network to the network control means to identify the user device and to request authorisation for operation of the identified user device, the network control means being operable in response to a request message to determine if the identified user device is authorised to use the network, and to send an authorising message to the identified user device in the event that it is so authorised, the device control means being arranged to disable the corresponding operation of the user device unless an authorising message has been received.

Preferably the said operation comprises communication by means of the network. Alternatively, the operation may be performed locally by the user device, once authorised, without communication by means of the network. The operation may include execution of software locally by the user device.

Preferably the communications network is a mobile communication network, in which at least some of the user devices are mobile while remaining operable for communication with the network. Preferably the communications network provides wireless communication with the user devices.

The or each user device may be additionally required to identify the user of the user device before communication is authorised. The user may be identified by means of an identification device removably connectable with the user device and containing information which identifies the user.

Preferably a database is associated with the network control means, the database containing identification details of user devices authorised to use the network, the network control means being operable to consult the database in response to a request message, and to send an authorising message only if the database contents indicate that the identified user device is authorised. The database may be operable to remove a user device from the group of authorised user devices in the event that the user device is reported as stolen.

Preferably the device control means sends a request message at least when communication with the network is being initiated. A request message may specify a service requested by the user of the user device and be sent in response to a request by the user to initiate access to the specified service, the network control means being operable to determine if the user device is authorised for use with the requested service.

Preferably the device control means includes authorisation software operable, when executed, to cause a request message to be sent. The device control means may comprise a computing device and operating system software controlling the computing device, the authorisation software forming a component of the operating system. Alternatively, the authorisation software may be installed in the user device in response to a user request for an additional service available over the communication network, and be further operable to provide access to the additional service, by means of the identified user device, in response to an authorising message.

The present invention provides a method of providing control in a communications network of the type which includes a plurality of user devices operable to communicate with each other by means of signals propagated over the network, and network control means operable to authorise user devices, wherein user devices send a request message over the network to the network control means to identify the user device and to request authorisation for operation of the identified user device, the network control means determines if the identified user device is authorised, and sends an authorising message to the identified user device in the event that it is so authorised, the devices having control means arranged to disable the corresponding operation of the user device unless an authorising message has been received.

Preferably the said operation comprises communication by means of the network. Alternatively, the operation may be performed locally by the user device, once authorised, without communication by means of the network. The operation may include execution of software locally by the user device.

Preferably the communications network is a mobile communication network, in which at least some of the user devices are mobile while remaining operable for communication with the network. Preferably the communications network provides wireless communication with the user devices.

The user device may identify the user of the user device before communication is authorised. The user may be identified by means of an identification device removably connectable with the user device and containing information which identifies the user.

Preferably the network control means consults a database in response to a request message, the database containing identification details of user devices authorised to use the network, and the network control means sends an authorising message only if the database contents indicate that the identified user device is authorised. The database may be operable to remove a user device from the group of authorised user devices in the event that the user device is reported as stolen.

Preferably a user device sends a request message at least when communication with the network is being initiated. A request signal may specify a service requested by the user of the user device and be sent in response to a request by the user to initiate access to the specified service, the network control means being operable to determine if the user device is authorised for use with the requested service.

Preferably the or each device includes authorisation software operable, when executed, to cause a request message to be sent. The or each device may comprise a computing device and operating system software controlling the computing device, the authorisation software forming a component of the operating system. Alternatively, the authorisation software may be installed in the user device in response to a user request for an additional service available over the communication network, and be further operable to provide access to the additional service, by means of the identified user device, in response to an authorising message.

The invention also provides a security arrangement for a communications network of the type which includes a plurality of user devices operable to communicate with each other by means of signals propagated over the network, and network control means operable to authorise operation of the user devices, wherein the network control means is operable to receive request messages over the network, the request messages serving to identify the user device sending the message and to request authorisation for operation of the identified user device, the network control means being operable in response to a request message to determine if the identified user device is authorised, and to send an authorising message to the identified user device in the event that it is so authorised.

Preferably the said operation comprises communication by means of the network. Alternatively, the operation may be performed locally by the user device, once authorised, without communication by means of the network. The operation may include execution of software locally by the user device.

Preferably the communications network is a mobile communication network. Preferably the communications network provides wireless communication from the control means to the user devices.

Preferably a database is associated with the network control means, the database containing identification details of user devices authorised to use the network, the network control means being operable to consult the database in response to a request message, and to send an authorising message only if the database contents indicate that the identified user device is authorised. The database may be operable to remove a user device from the group of authorised user devices in the event that the user device is reported as stolen.

A request message may specify a service requested by the user of the user device and be sent in response to a request by the user to initiate access to the specified service, the network control means being operable to determine if the user device is authorised for use with the requested service.

In another aspect, the present invention provides a security arrangement for a communications network of the type which includes a plurality of user devices operable to communicate with each other by means of signals propagated over the network, and network control means operable to authorise the use of the network, wherein at least one of the devices has device control means operable to send a request message over the network to the network control means to identify the user device and to request authorisation for operation of the identified user device, the device control means being arranged to disable the corresponding operation of the user device unless an authorising message has been received.

Preferably the said operation comprises communication by means of the network. Alternatively, the operation may be performed locally by the user device, once authorised, without communication by means of the network. The operation may include execution of software locally by the user device.

Preferably the communications network is a mobile communication network, in which at least some of the user devices are mobile while remaining operable for communication with the network. Preferably the communications network provides wireless communication with the user devices.

The or each user device may be additionally required to identify the user of the user device before communication is authorised. The user may be identified by means of an identification device removably connectable with the user device and containing information which identifies the user.

Preferably the device control means sends a request message at least when communication with the network is being initiated. A request message may specify a service requested by the user of the user device and be sent in response to a request by the user to initiate access to the specified service, the device control means being arranged to prevent use of the requested service unless an authorising message has been received.

Preferably the device control means includes authorisation software operable, when executed, to cause a request message to be sent. The device control means may comprise a computing device and operating system software controlling the computing device, the authorisation software forming a component of the operating system. Alternatively, the authorisation software may be installed in the user device in response to a user request for an additional service available over the communication network, and be further operable to provide access to the additional service, by means of the identified user device, in response to an authorising message.

Embodiments of the present invention will now be described in more detail, by way of example only, and with reference to the accompanying drawings, in which:

FIG. 1 is a schematic illustration of a mobile wireless communication network in which the present invention is implemented;

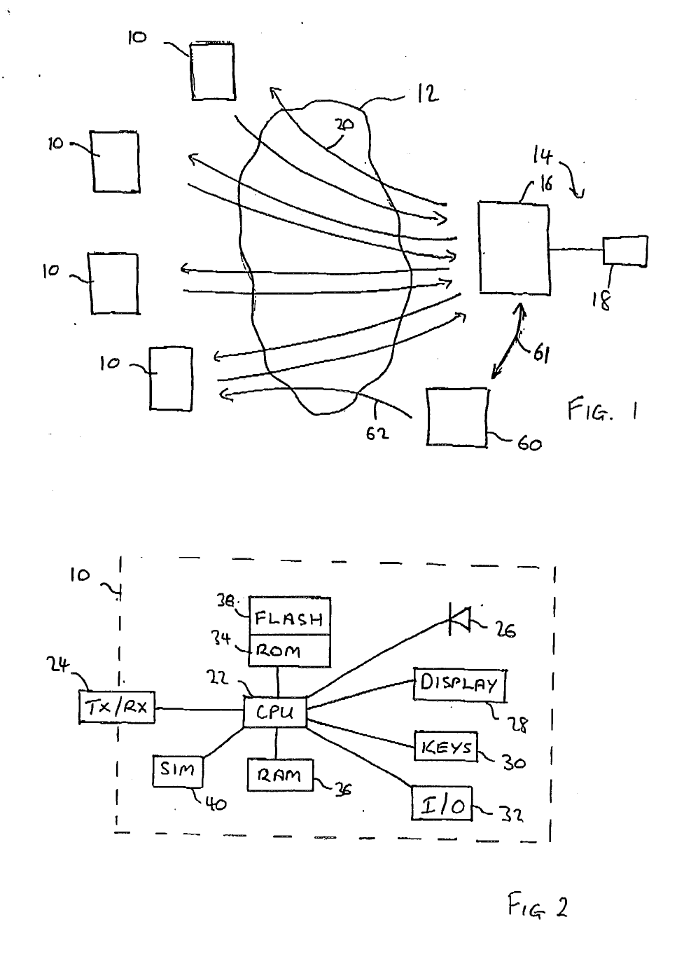

FIG. 2 is a simplified schematic diagram of a mobile user device for use in the network of FIG. 1;

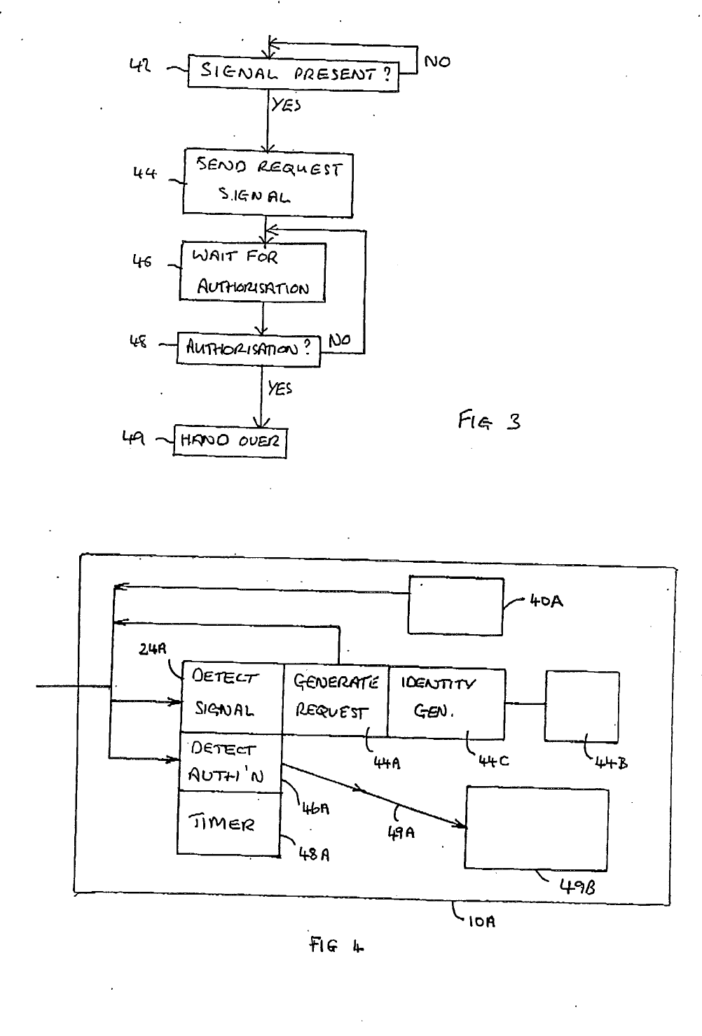

FIG. 3 is a flow diagram of operation of the user device in order to initiate communication with the network of FIG. 1;

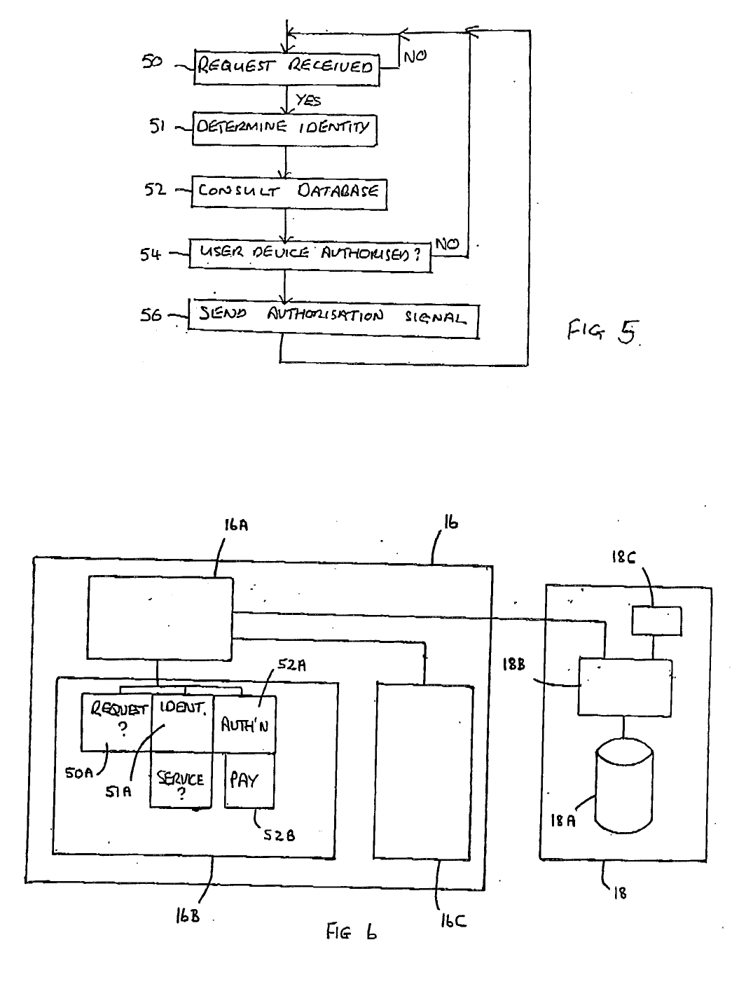

FIG. 4 is a schematic diagram of software and data modules within the user device;

FIG. 5 is a flow diagram of the response of the network control arrangements to the receipt of a request signal from a user device;

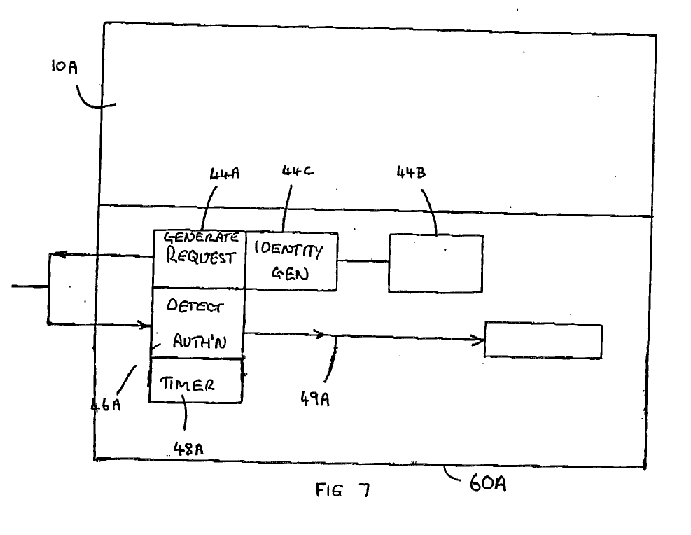

FIG. 6 is a schematic diagram of software and data modules within the network control; and

FIG. 7 corresponds generally with FIG. 4, showing a software application.

### OVERVIEW

FIG. 1 illustrates a plurality of user devices 10. The user devices are mobile communication devices such as mobile telephones, portable personal communication devices or the like. Each device 10 is preferably operable to provide voice communication, at least, and may also provide other forms of communication such as data communication, internet connectivity, WAP connectivity, text (SMS) messaging facilities and the like.

These communication functions require access to a communication network 12, to which each device 10 must obtain access in order to send or receive messages. In this specification, the term “message” is used to encompass any format or content of message and “communication” is used to encompass bi-directional transmission of messages, or uni-directional transmission in either direction.

The network 12, and hence the communication of messages between the devices 10, is controlled at 14 by a network control system 16. This provides routing control for messages travelling over the network, which may be provided in a conventional manner and the details of which are not part of the present invention. The network control system 16 is illustrated as a single entity, but in reality, the control functions, particularly routing control, are likely to be distributed throughout the network 12, and the arrangements will include a network provider and one or more service providers.

In addition to conventional network control functions, and in accordance with the invention, the control system 16 provides additional security functions. These may now be described briefly, and will be described in more detail below.

Briefly, a user device 10 which seeks to initiate communication over the network 12, must first identify itself to the control system 16, by sending a request message seeking authorisation for the identified user device to use the network. It is important to note that it is the device, not the user which is identified in the request message.

The control system 16 has access to a database 18 which contains details of all user devices 10 authorised for use with the network 12. Again, it is important to note that it is the devices 10 which are authorised, not the users, although users may also be authorised as part of a separate process.

When the control system 16 receives a request message from a user device seeking access to the network 12, the system 16 will consult the database 18 to determine if the identified user device 10 is authorised to use the network. In the event that the database 18 records the identified user device as being so authorised, the control system 16 sends an authorising message 20 to the identified device 10. A control arrangement within the device 10 prevents the device from functioning unless an authorising message has been received.

Consequently, a stolen user device 10 can be disabled from further use with the network 12 by modifying the database 18 to remove that user device from the group of authorised user devices. This can be done in response to a report that the user device has been stolen. When that user device is next used to gain access to the network, even if the SIM card has been replaced with a legitimate SIM card, the control system 16 will determine that the identified user device is no longer authorised for use. The authorising message 20 will not be sent. The user device 10 is therefore of no further use. The stolen user device 10 is therefore no longer of value to the wrongful possessor of the device.

It is envisaged that by disabling the user device 10 in this manner, the stolen user device will be valueless from the time at which the theft is reported and consequently, we expect that devices protected in accordance with the invention will cease to be attractive to thieves.

User Device

Before discussing in more detail the sequence of steps used to authorise or disable a user device 10 in the manner just described, it is first appropriate to describe the construction and operation of a user device 10 in additional detail, with reference to FIG. 2.

FIG. 2 schematically represents a mobile wireless communication device 10, such as a mobile telephone. This is constructed around a central processing device 22, which may be a microprocessor, for example. Transmitter and receiver circuits 24 permit wireless communication between the device 10 and the network 12. Speech messages which are received at 24 are sent by the processor 22 to a speaker and microphone arrangement at 26, which also serves as a transducer for the voice of the user, in order to send speech messages to the network 12. A display 28 allows received messages, such as text messages, to be displayed for the user. The display 28 may be a screen allowing the display of information such as a website, particularly a WAP website to which the device 10 is connected, or may be a screen on which an auxiliary service, such as a streamed (continuously transmitted) video signal of a film, sport or other entertainment can be viewed. A keyboard 30 or other user control is provided for controlling the device 10, entering text messages etc. Other input and/or output devices 32 may also be provided, such as data ports.

Operation of these components is controlled by the processor 22 which in turn has a software operating system stored permanently in read-only memory (ROM) 34 and which is loaded for use into main memory 36 in the form of random access memory (RAM). Additional memory 38 is provided in the form of flash RAM, to which additional software can be downloaded, in circumstances to be described.

The processor 22 also has access to a SIM card holder 40 into which a SIM card must be installed for the processor 22 to operate.

When the user device 10 is switched on, or first instructed to seek access to the network 12, the operating system or the relevant part of the operating system will be loaded from ROM 34 into RAM 36 for execution. One function of the operating system 10A in initiating communication with the network 12 is illustrated in simplified form in FIG. 3. Software modules which effect the function are illustrated in FIG. 4. FIG. 4 schematically illustrates relevant software modules of the operating system of the user device 10.

This function begins by using the transceiver circuit 24 to listen for an adequate signal from the network 12. A software module 24A (labelled DETECT SIGNAL) continues to listen until an adequate signal is detected. A software module 44A (GENERATE REQUEST) prepares and sends at step 44 a request signal, requesting access to the network. The request signal is sent by the transceiver 24, across the network 12, to the network control system 16. The request signal identifies the user device 10 by a unique identification, which may be identification data permanently incorporated into the user device during manufacture, stored, for example, at 44B and recovered by an identity generating software module 44C which retrieves the data from 44B and creates identification data in appropriate form for transmission by the module 44A. Alternatively, the identity module 44C may execute an algorithm which creates the next member of a sequence of identification known to the processor 22 and to the system 16. Many other arrangements could be envisaged for creating a unique identifier which identifies the user device 10 being used. Again, it is important to note that it is the device, not the user, which is identified. At this stage, data on the SIM card 40 is not required.

After sending the request signal at step 44, the device 10 waits at step 46 for an authorisation signal to be received from the system 16. The authorisation signal is detected by a software module 46A, which monitors signals received by the device 10. If no authorisation signal is detected at 48, the processor 22 continues to wait at 46. In the event that an authorisation signal continues to be absent, the processor 22 may be arranged to time-out the function and revert to a quiescent state in which communication over the network 12 has not been established. The time-out is controlled by a software module 48A, which disables the sequence of operations after a pre-set period of time. Consequently, communication cannot be established unless an authorisation signal is received from the system 16. When this is detected by the module 46A, the function shown in FIG. 3 is completed by handing operation of the processor 22 back to the operating system 10A at 49. This is illustrated by the module 46A handing over control, at 49A, to other modules 49B, which provide the remaining functions of the operating system and do not themselves form part of the invention. That the user is then free to make use of the facilities provided within the device 10 and controlled by the operating system 10A.

Operation of Network Control System

FIG. 5 illustrates the sequence of operation of the control system 16 when request signal is received from a user device 10 implementing the process illustrated in FIG. 3. Software modules which affect this function are illustrated in FIG. 6. FIG. 6 illustrates relevant software modules of the operating system of the control system 16. The control system may be the system of the network operator, or of a service provider whose services are provided by means of the network. The control system 16 is shown in simplified form, comprising a processor 16A, and an operating system 16B loaded for execution from auxiliary memory 16C.

The control system 16 continuously monitors at step 50 for receipt of request signals from user devices seeking to gain access to the network 12. This is achieved by a software module 50A, which monitors signals received from user devices 10. When a request signal is received, a software module 51A analyses the signal to determine (step 51) the identity of the user device 10 identified in the request signal. A module 51B may also be executed to analyse the request signal to determine the nature of the request, which may be for a particular service (see below). The database 18 is then consulted at 52, by a software module 52A (AUTHN), to determine if the identified user device 10 is authorised for access to the network. The database 18 includes data storage 18A and a software module 18B which responds to read requests to provide information from the data store 18A, and responds to write requests to modify the contents of the store 18A. Input and output devices 18C allow the contents of the store 18A to be modified by the proprietor of the database. The data store 18A contains details of the user devices 10 which can or cannot be authorised to use the network. In particular, the module 52A will find that the database 18 does not authorise the device 10 in the event that the identified device 10 has been reported as stolen. In that case, the entry in the database 18 corresponding to the identified user device will have been removed or modified to indicate that the device can no longer be authorised.

If the system 16 determines at 54 that the identified user device has not been authorised, the system 16 reverts to listening for request signals at 50, without having sent an authorisation signal.

However, if the identified user device is found to be acceptable for authorisation by reference to the contents of the database 18, an authorisation signal is sent at step 56 by the authorisation module 52A to the identified user device 10 over the network 12. It is this authorisation signal for which the user device 10 waits at step 48 in FIG. 3.

Consequently, an individual user device 10 can be rendered useless on the network 12 merely by modifying the contents of the database 18. The database 18 will be maintained and secured by the network operator.

Successful operation of the authorisation module 52A may require execution of a software module 52B which effects a payment routine, such as to charge the credit card account of the recorded owner of the user device identified in the request message.

Auxiliary Services

The arrangements described above have been set out in relation to the basic facility of access to the communication services provided by the network 12. That is to say, the arrangements cause the operating system of the device 10 to be prevented from operation unless authorised.

In a modification of the arrangements described above, they can be used to allow authorised access to ancillary services without hindering access to basic services of the network. In this connection, it is envisaged that, as bandwidth on communication networks increases, and processing power within user devices 10 also increases, a wider range of auxiliary services will become available to users. For example, devices 10 which have adequate screens may become used for video viewing, particularly of films, sport or other entertainment. The following example illustrates the manner in which the present invention may be applied in relation to such auxiliary services.

Turning first to FIG. 1, there is illustrated an auxiliary service provider 60, such as a video source. Access to the video source 60 may be by subscription, or on a pay-per-view basis or unlimited within a period of time determined by a payment previously made.

Viewing a video signal streamed (i.e. continuously transmitted) from the video source 60 to a user device 10 may require the user device 10 to have additional software installed. This software may be a viewer application for decoding the video stream and may be stored in the flash RAM 38, having been downloaded in preparation for subsequent use. FIG. 7 corresponds generally with FIG. 4, but shows a viewer application 60A. Some of the software modules described in relation to FIG. 4 are embedded in the application 60A in FIG. 7, rather than in the operating system 10A, but are otherwise alike in operation, as will be described.

Execution of the viewer software 60A is required for successful viewing of the video stream 62. However, successful execution of the auxiliary software itself requires the user device to be authorised to receive the video stream 62. This authorisation process takes place in accordance with the principles described above in relation to FIGS. 3 to 6. That is, the viewer software 60A will send a request signal identifying the user device from the module 44A, and will not complete execution unless an appropriate authorisation signal has been received, as detected by the module 46A. In the event that no authorisation signal is received (i.e. the operation times out under control of the module 48A), execution of the video viewer will not occur and the video stream 62 will not be viewable at the user device. When an authorisation signal is received, detected by the module 46A, control is handed at 49A to the remaining functions of the application.

Authorisation for receipt of the video stream 62 may be implemented in the manner described above, by the control system 16 in consultation with the database 18. If so, the database 18 will contain information about the authorisation of each user device 10 for each service or auxiliary service available over the network 12. Consequently, the request message from module 44A will be required to identify the requested service, and the module 51A will be required to read this information from the request signal, for use by the authorisation module 52A. Alternatively, authorisation in relation to the video stream 62 may be handled at the auxiliary service 60 by means of a control system operating in a similar manner to the system 16, and with access to a database equivalent to the database 18, but concerned only with the identification of user devices authorised to have access to the video stream 62.

In that case, request signals relating to operation of the video viewer would be directed over the network 12 to the auxiliary service 60, not to the control system 16. This will only be possible if the user device has previously been authorised by the system 16 to communicate over the network 12. Consequently, in this second example, the network operator is required only to maintain a database 18 which gives details of user devices and their authorisation for access to the basic facilities of the network 12. Facilities available over the network can be increased by other commercial operators providing auxiliary services and maintaining an associated database relating only to the authorisation of user devices to gain access to that particular auxiliary service. This authorisation can be provided in return for a payment made by the user to the proprietor of the auxiliary service 60. It is not necessary for the network operator to be involved in this commercial transaction. Alternatively, the network operator may wish to have the user transact commercially only with themselves in relation to services available over the network 12, in order to enhance the value of the network as perceived by users. In that example, request signals relating to the auxiliary service 60 may be answered by the system 16 in consultation with the database 18, or may be routed from the system 16 to the auxiliary service 60, as illustrated at 61. Payments would be from the user to the network operator, who would have a separate commercial arrangement with the proprietor of the auxiliary service 60.

Consequently, it will be apparent that a sophisticated device 10, equipped with a screen and software for viewing the video stream 62 is nevertheless unable to do so once recorded as stolen. The value of a sophisticated device to a thief is therefore significantly reduced.

Use of SIM Cards

The description set out above has emphasised that request signals identify the user device 10, not the user. However, it is envisaged that a SIM card will normally be incorporated into the device 10 for conventional reasons. Thus, in addition to the user device 10 being itself authorised to gain access to the network 12, the SIM card 40 can also be used to complete a further authorisation procedure by means of a software module 40A, equivalent to that of a conventional arrangement, in order to authorise the user to gain access to the network 12 For example, identification of the user by means of the SIM card provides a simple manner of barring or allowing access to particular services, such as international calls, preferential billing rates etc.

A further advantage becomes apparent when the invention requiring identification of the user device is used in conjunction with a SIM card to identify the user. For example, authorisation to access the network 12 can require successful authorisation of the user device 10, and also authorisation of the SIM card (and thus the user), as has been described. In the example set out above, FIG. 3 indicates that the processor 22 fails to complete the authorisation of the device 10, in the event that the database contents indicate that the device 10 is not authorised. However, it is envisaged that the system 16 could be configured to recognise a request signal from a user device 10 which is recorded in the database 18 as being stolen, and then to allow the device 10 to complete the conventional procedure by which the SIM card 40 is used to identify the current user of the device 10. In the case of a stolen device 10, the SIM card of the legitimate user would normally be removed and replaced by a valid SIM card of the new user. Completing the SIM card identification process allows the network operator to identify the user now in possession of the device. The network operator will have a record of personal details of the SIM card holder, for billing purposes. Consequently, that new user is readily identified as knowing the whereabouts of the device 10. It is appreciated that the new user may not have been the thief and indeed, may have purchased the device 10 in good faith. However, readily identifying the new user in this manner is envisaged to be of significant assistance to law enforcement authorities seeking to identify and prosecute the thief.

Protection of the Software

The advantages of the invention, as set out above, would be circumvented in the event that the requirement for the software to send a request signal and to await an authorisation signal could be avoided. It is envisaged that various precautions can be taken to reduce this risk sufficiently as to remove it as a practical problem. For example, in the event that the device 10 contains ROM 34 but no flash RAM 38, so that additional software cannot be downloaded to the device 10, the software within the ROM 34 will run in the same manner on each occasion and the security procedures within it cannot be circumvented.

However, the likely presence of flash RAM 38 or equivalent memory, in future devices, and the desirability of being able to download additional software, for upgrading the existing operating system or for gaining access to auxiliary services, renders the security processes potentially vulnerable to attack by software which, when executed, serves to circumvent the security procedures which have been described. A number of procedures for protecting software against attacks of this nature have been described previously by ourselves, for example in International patent application No. WO 02/06925, the contents of which are incorporated herein, by way of reference. The International patent application describes arrangements which allow software, and particularly the security procedures within it, to be hidden from analysis by an authorised user seeking to circumvent protection, or to appear in a different form or at a different location on each occasion the software is executed, thus preventing the righting of a routine which provides a generic solution to circumventing the security arrangements. One or more of those techniques could be incorporated within the device 10 to provide protection for the security arrangements included within the software described.

Variations and Modifications

It will be readily apparent from the above description that very many alternative arrangements and specific hardware and software technologies can be envisaged for implementing the invention, and the scope of the invention is not to be considered limited to any particular choice of these technologies.

The examples described above have suggested that an authorisation signal authorises software to execute, and thus disable the software if not received. These arrangements can be used to authorise or disable operations which require a user device to communicate by means of the network, or operations which do not require such communication, once the user device has received authorisation. For example, the user device may contain software, such as a game or other licensed application, which has a security function requiring execution of the software to be authorised. The security function may use communication over the network, to seek authorisation from the network control arrangements. Authorisation may be sought each time the software runs, or each authorisation may allow the software to be run a given number of times, or over a set period. In the latter options, the software remains executable, to a limited degree, even if the user device is out of range of the network, or otherwise unable to access it. In a more complex alternative, various authorisation signals may be possible, for example to define a selection of functions to which access is authorised or barred.

It is currently envisaged that many future mobile user devices 10 will operate with software written in the JAVA language. The JAVA language has been developed particularly for use with mobile devices. However, JAVA contains various restrictions within its protocols. For example, there are restrictions on JAVA code being modified, but not on the modification of data within JAVA code. Restrictions of this nature may restrict the freedom with which the security arrangements of our previous International patent application can be used.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A security arrangement for a communications network of the type which includes a plurality of user devices operable to communicate with each other by means of signals propagated over the network, and network control means operable to authorise user devices, wherein at least one of the devices has device control means operable to send a request message over the network to the network control means to identify the user device and to request authorisation for operation of the identified user device, the network control means being operable in response to a request message to determine if the identified user device is authorised to use the network, and to send an authorising message to the identified user device in the event that it is so authorised, the device control means being arranged to disable the corresponding operation of the user device unless an authorising message has been received.

2. An arrangement according to claim 1, wherein the said operation comprises communication by means of the network.

3. An arrangement according to claim 1, wherein the said operation may be performed locally by the user device, once authorised, without communication by means of the network.

4. An arrangement according to claim 1, wherein the said operation includes execution of software locally by the user device.

5. An arrangement according to claim 1, wherein the communications network is a mobile communication network, in which at least some of the user devices are mobile while remaining operable for communication with the network.

6. An arrangement according to claim 1, wherein the communications network provides wireless communication with the user devices.

7. An arrangement according to claim 1, wherein the or each user device is additionally required to identify the user of the user device before communication is authorised.

8. An arrangement according to claim 7, wherein the user is identified by means of an identification device removably connectable with the user device and containing information which identifies the user.

9. An arrangement according to claim 1, wherein a database is associated with the network control means, the database containing identification details of user devices authorised to use the network, the network control means being operable to consult the database in response to a request message, and to send an authorising message only if the database contents indicate that the identified user device is authorised.

10. An arrangement according to claim 9, wherein the database is operable to remove a user device from the group of authorised user devices in the event that the user device is reported as stolen.

11. An arrangement according to claim 1, wherein the device control means sends a request message at least when communication with the network is being initiated.

12. An arrangement according to claim 1, wherein a request message is able to specify a service requested by the user of the user device and be sent in response to a request by the user to initiate access to the specified service, the network control means being operable to determine if the user device is authorised for use with the requested service.

13. An arrangement according to claim 1, wherein the device control means includes authorisation software operable, when executed, to cause a request message to be sent.

14. An arrangement according to claim 1, wherein the device control means comprises a computing device and operating system software controlling the computing device, the authorisation software forming a component of the operating system.

15. An arrangement according to claim 1, wherein the authorisation software is installed in the user device in response to a user request for an additional service available over the communication network, and is further operable to provide access to the additional service, by means of the identified user device, in response to an authorising message.

16. A method of providing control in a communications network of the type which includes a plurality of user devices operable to communicate with each other by means of signals propagated over the network, and network control means operable to authorise the user devices, wherein user devices send a request message over the network to the network control means to identify the user device and to request authorisation for operation of the identified user device, the network control means determines if the identified user device is authorised to use the network, and sends an authorising message to the identified user device in the event that it is so authorised, the devices having control means arranged to disable the corresponding operation of the user device unless and authorising message has been received.

17. An arrangement according to claim 16, wherein the said operation comprises communication by means of the network.

18. An arrangement according to claim 16, wherein the said operation may be performed locally by the user device, once authorised, without communication by means of the network.

19. An arrangement according to claim 16, wherein the said operation includes execution of software locally by the user device.

20. A method according to claim 16, wherein the communications network is a mobile communication network, in which at least some of the user devices are mobile while remaining operable for communication with the network.

21. A method according to claim 16, wherein the communications network provides wireless communication with the user devices.

22. A method according to claim 16, wherein the user device identifies the user of the user device before communication is authorised.

23. A method according to claim 22, wherein the user is identified by means of an identification device removably connectable with the user device and containing information which identifies the user.

24. A method according to claim 16, wherein the network control means consults a database in response to a request message, the database containing identification details of user devices authorised to use the network, and the network control means sends an authorising message only if the database contents indicate that the identified user device is authorised.

25. A method according to claim 24, wherein the database is operable to remove a user device from the group of authorised user devices in the event that the user device is reported as stolen.

26. A method according to claim 16, wherein a user device sends a request message at least when communication with the network is being initiated.

27. A method according to claim 16, wherein a request signal is able to specify a service requested by the user of the user device and be sent in response to a request by the user to initiate access to the specified service, the network control means being operable to determine if the user device is authorised for use with the requested service.

28. A method according to claim 16, wherein each device includes authorisation software operable, when executed, to cause a request message to be sent.

29. A method according to claim 28, wherein the or each device comprises a computing device and operating system software controlling the computing device, the authorisation software forming a component of the operating system.

30. A method according to claim 28, wherein the authorisation software is installed in the user device in response to a user request for an additional service available over the communication network, and is further operable to provide access to the additional service, by means of the identified user device, in response to an authorising message.

31. A security arrangement for a communications network of the type which includes a plurality of user devices operable to communicate with each other by means of signals propagated over the network, and network control means operable to authorise operation of the user devices, wherein the network control means is operable to receive request messages over the network, the request messages serving to identify the user device sending the message and to request authorisation for operation of the identified user device, the network control means being operable in response to a request message to determine if the identified user device is authorised, and to send an authorising message to the identified user device in the event that it is so authorised.

32. An arrangement according to claim 31, wherein the said operation comprises communication by means of the network.

33. An arrangement according to claim 31, wherein the said operation may be performed locally by the user device, once authorised, without communication by means of the network.

34. An arrangement according to claim 31, wherein the said operation includes execution of software locally by the user device.

35. An arrangement according to claim 31, wherein the communications network is a mobile communication network.

36. An arrangement according to claim 31, wherein the communications network provides wireless communication from the control means to the user devices.

37. An arrangement according to claim 31, wherein a database is associated with the network control means, the database containing identification details of user devices authorised to use the network, the network control means being operable to consult the database in response to a request message, and to send an authorising message only if the database contents indicate that the identified user device is authorised. The database may be operable to remove a user device from the group of authorised user devices in the event that the user device is reported as stolen.

38. An arrangement according to claim 31, wherein a request message is able to specify a service requested by the user of the user device and be sent in response to a request by the user to initiate access to the specified service, the network control means being operable to determine if the user device is authorised for use with the requested service.

39. A security arrangement for a communications network of the type which includes a plurality of user devices operable to communicate with each other by means of signals propagated over the network, and network control means operable to authorise the use of the network, wherein at least one of the devices has device control means operable to send a request message over the network to the network control means to identify the user device and to request authorisation for operation of the identified user device, the device control means being arranged to disable the corresponding operation of the user device unless an authorising message has been received.

40. An arrangement according to claim 39, wherein the said operation comprises communication by means of the network.

41. An arrangement according to claim 39, wherein the said operation may be performed locally by the user device, once authorised, without communication by means of the network.

42. An arrangement according to claim 39, wherein the said operation includes execution of software locally by the user device.

43. An arrangement according to claim 39, wherein the communications network is a mobile communication network, in which at least some of the user devices are mobile while remaining operable for communication with the network.

44. An arrangement according to claim 39, wherein the communications network provides wireless communication with the user devices.

45. An arrangement according to claim 39, wherein the or each user device is additionally required to identify the user of the user device before communication is authorised.

46. An arrangement according to claim 39, wherein the user is identified by means of an identification device removably connectable with the user device and containing information which identifies the user.

47. An arrangement according to claim 39, wherein the device control means sends a request message at least when communication with the network is being initiated.

48. An arrangement according to claim 39, wherein a request message specifies a service requested by the user of the user device and is sent in response to a request by the user to initiate access to the specified service, the device control means being arranged to prevent use of the requested service unless an authorising message has been received.

49. An arrangement according to claim 39, wherein the device control means includes authorisation software operable, when executed, to cause a request message to be sent.

50. An arrangement according to claim 49, wherein the device control means comprises a computing device and operating system software controlling the computing device, the authorisation software forming a component of the operating system.

51. An arrangement according to claim 49, wherein the authorisation software may be installed in the user device in response to a user request for an additional service available over the communication network, and be further operable to provide access to the additional service, by means of the identified user device, in response to an authorising message.
